(19) United States
(12) Patent Application Publication
(10) Pub. No.: US 2007/0292239 A1
(43) Pub. Date: Dec. 20, 2007

(54) Screw strip with ribs extending along full length thereof

(75) Inventor: Chao-Wei Lin, Tainan City (TW)

Correspondence Address: LADAS & PARRY, 26 WEST 61ST STREET, NEW YORK, NY, 10023, US

(73) Assignee: KWANTEX RESEARCH INC.

(21) Appl. No.: 11/443,636

(22) Filed: May 31, 2006

(51) Int. Cl. F16B 15/08; B65D 85/24

(52) U.S. Cl. 411/442; 206/345

(57) ABSTRACT

A screw strip for holding a plurality of screws has a plurality of screw-holding strip portions for holding respectively the screws. Each of the screw-holding strip portions includes a plurality of resilient clamping arms for clamping the corresponding screw. Two opposite sides of the screw strip are formed respectively with two long ribs extending along a full length of the screw strip. Each side of the screw strip is further formed with a plurality of spaced-apart wings located outside of the corresponding long rib.

### BACKGROUND OF THE INVENTION

1. Field of the Invention

This invention relates to a screw holder, and more particularly to a screw strip for holding a plurality of screws thereon.

2. Description of the Related Art

Referring to FIG. 1, a first conventional screw strip includes a strip body 20, and a plurality of sleeves 21 each formed with a plurality of slots 23. Referring to FIG. 2, a plurality of screws 1 can be clamped respectively within the sleeves 21. When one screw 1 is driven into a workpiece (not shown) by means of a pneumatic screw-driving device 3, the sleeve 21 is ruptured by a head of the screw 1. The pneumatic screw-driving device 3 is formed with two guide slots 31. Two opposite lateral sides of the strip body 20 can be moved within the guide slots 31 in the pneumatic screw-driving device 3. A drawback of the first conventional screw strip is that the screw-driving operation of the screw-driving device 3 may result in deformation of the strip body 20 into an arch shape due to separation of the opposite lateral sides of the strip body 20 from the guide slots 31, respectively. If this occurs, the screw 1 cannot be driven accurately into the workpiece.

To provide an improvement over the first conventional screw strip, as shown in FIG. 3, each side of a second conventional screw strip is designed to have a plurality of spaced-apart wings 41 each formed with a short rib 42. Any two adjacent wings 41 define a notch 43. To use the second conventional screw strip, a pneumatic screw-driving device (not shown) includes two spring-biased positioning members slidable on the wings 41 and engageable with two selected ones of the notches 43, and two rib-engaging slots for sliding movement of the short ribs 42 therealong. Although the deformation of the second conventional screw strip can be diminished, when the screw-driving operation is performed, the short ribs 42 may separate from the rib-engaging slots in the pneumatic screw-driving device in view of the fact that any two adjacent short ribs 42 are divided by a corresponding one of the notches 43. As a result, it is still possible for the lateral sides of the second conventional screw strip to separate from the guide slots in the pneumatic screw-driving device.

### SUMMARY OF THE INVENTION

Therefore, the object of this invention is to provide a screw strip that does not undergo deformation when a screw-driving operation is performed and that allows the screws held thereon to be driven accurately into a workpiece.

According to this invention, a screw strip is provided for holding a plurality of screws. The screws extend through the screw strip. The screw strip has a plurality of screw-holding strip portions for holding the screws respectively. Each of the screw-holding strip portions includes an annular strip body having a side surface, a pair of parallel first and second short ribs extending respectively and integrally from two opposite sides of the side surface of the strip body, and a plurality of resilient clamping arms extending from an inner periphery of the side surface of the strip body for clamping a corresponding one of the screws thereamong. Any two adjacent first short ribs are interconnected integrally such that the first short ribs constitute cooperatively a first long rib extending along a full length of the screw strip. Any two adjacent ones of the second short ribs are also interconnected integrally such that the second short ribs constitute cooperatively a second long rib extending along the full length of the screw strip. Each of the screw-holding strip portions further has a pair of first and second wings extending respectively and integrally from the opposite sides of a corresponding one of the screw-holding strip portions away from each other and disposed respectively in proximity to said first and second short ribs of the corresponding one of the screw-holding strip portions. Any two adjacent ones of the first wings are spaced apart from each other so as to define a first positioning notch therebetween. Any two adjacent ones of the second wings are also spaced apart from each other so as to define a second positioning notch therebetween.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary perspective view of a first conventional screw strip;

FIG. 2 is an end view of the first conventional screw strip, illustrating the use thereof;

FIG. 3 is a perspective view of a second conventional screw strip;

FIG. 4 is a perspective view of the first preferred embodiment of a screw strip according to this invention;

FIG. 5 is a perspective view of the first preferred embodiment, illustrating the use thereof;

FIG. 6 is an end view of the first preferred embodiment, illustrating the use thereof;

FIGS. 7 to 9 are respectively fragmentary top views of the second, third, and fourth preferred embodiments of a screw strip according to this invention, illustrating changes to the number of resilient clamping arms;

FIGS. 10 to 13 are respectively fragmentary top views of the fifth, sixth, seventh, and eighth preferred embodiments of a screw strip according to this invention, illustrating changes to both the number and shape of the resilient clamping arms;

FIG. 14 is a fragmentary perspective view of the ninth preferred embodiment of a screw strip according to this invention; and

FIG. 15 is an end view of the ninth preferred embodiment, illustrating the use thereof.

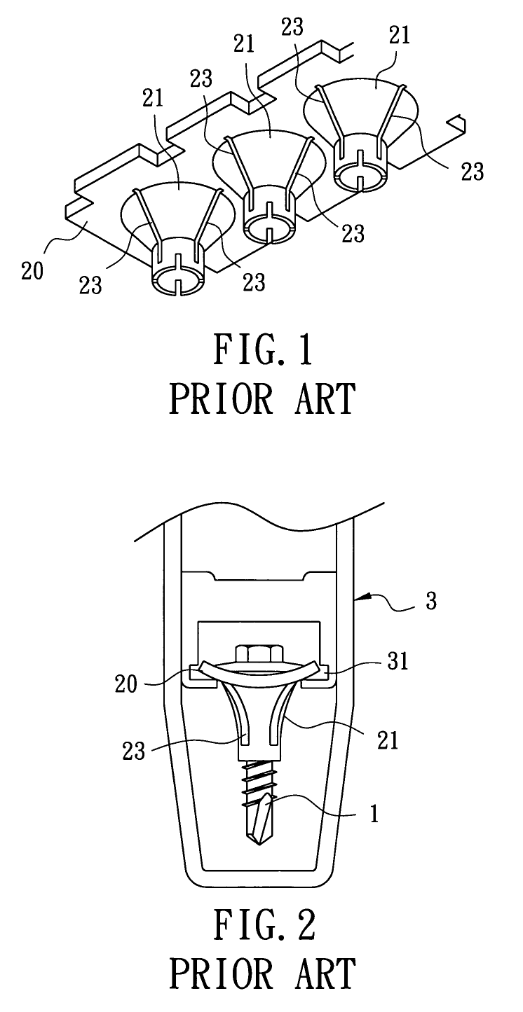

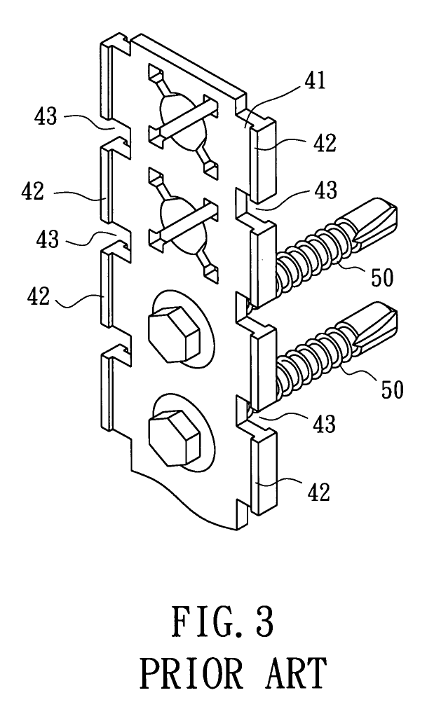

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

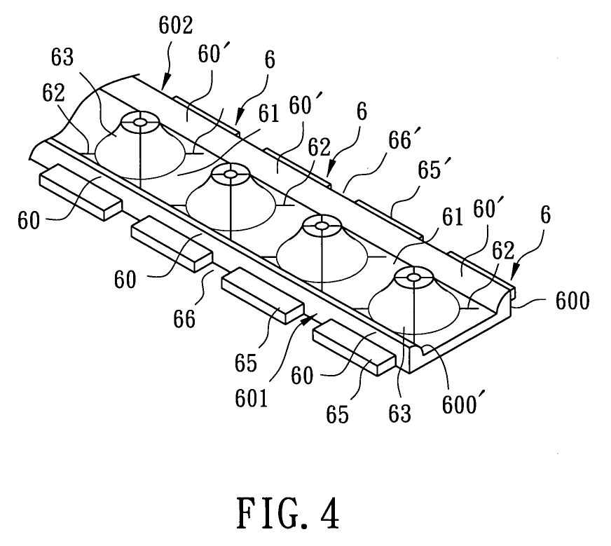

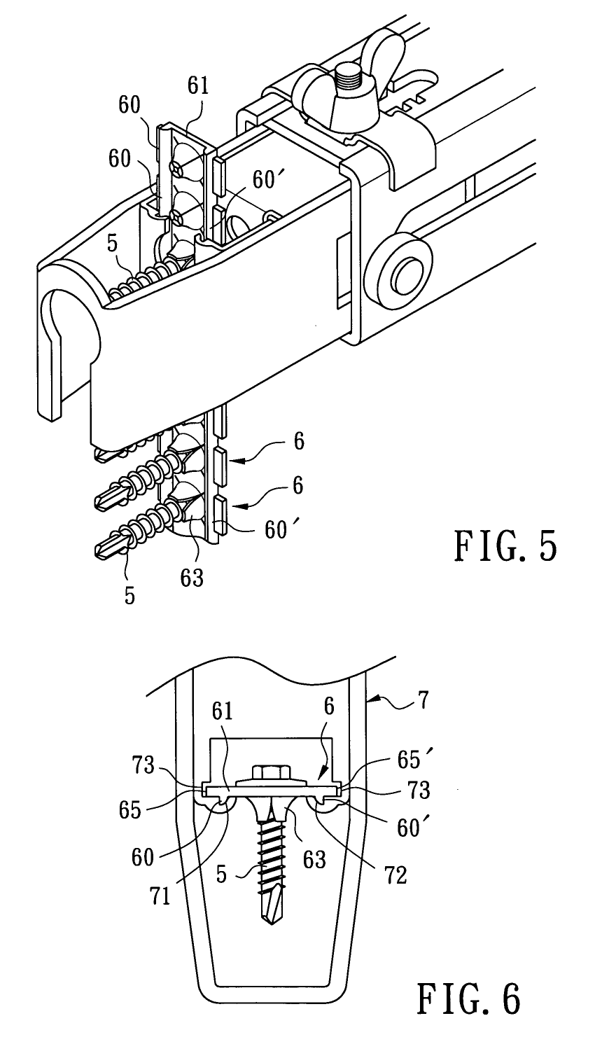

Referring to FIG. 4, the first preferred embodiment of a screw strip according to this invention has a plurality of screw-holding strip portions 6 for holding respectively a plurality of screws 5, as shown in FIG. 5. The screws 5 extend through the screw strip.

Each of the screw-holding strip portions 6 includes an annular strip body 61, a pair of parallel first and second short ribs 60, 60′, four resilient clamping arms 63, and a pair of first and second wings 65, 65′. Any two adjacent clamping arms 63 define an axially extending slot 62 therebetween.

The screw strip is formed by extrusion using a plastic composite material comprised of a plastic material and paper pulp, and optionally sawdust, and is subsequently punched and pressed to form the clamping arms 63.

The screw-holding strip portions 6 are similar in construction. One of the screw-holding strip portions 6 is described in the succeeding paragraph.

The first and second short ribs 60, 60′ extend respectively and integrally from two opposite sides of a side surface of the strip body 61. The clamping arms 63 extend from an inner periphery of the side surface of the strip body 61 for clamping the screw 5 thereamong. Any two adjacent first short ribs 60 are interconnected integrally such that the first short ribs 60 constitute cooperatively a first long rib 601, which extends along a full length of the screw strip and which is engageable with a first rib-engaging slot 71 in a pneumatic screw-driving device 7, as shown in FIG. 6. Any two adjacent second short ribs 60′ are also interconnected integrally such that the second short ribs 60′ constitute cooperatively a second long rib 602, which extends along the full length of the screw strip and which is engageable with a second rib-engaging slot 72 in the pneumatic screw-driving device 7. The first and second wings 65, 65′ extend respectively and integrally from the opposite sides of the strip body 61 away from each other, and are disposed respectively in proximity to and outside of the first and second short ribs 60, 60′. The pneumatic screw-driving device 7 is formed with two aligned guide slots 73 for receiving respectively, fittingly, and slidably the first and second wings 65, 65′.

Any two adjacent first wings 65 are spaced apart from each other so as to define therebetween a first positioning notch 66, which is engageable with one spring-biased positioning member (not shown) of the pneumatic screw-driving device 7.

Any two adjacent second wings 65′ are also spaced apart from each other so as to define therebetween a second positioning notch 66′, which is engageable with another spring-biased positioning member of the pneumatic screw-driving device.

Since the first and second long ribs 601, 602 extend along a full length of the screw strip, they are long and possess no gaps. As such, removal of the first and second long ribs 601, 602 from the rib-engaging slots 71, 72 in the pneumatic screw-driving device 7 can be prevented. This allows the screws 5 to be driven accurately into a workpiece (not shown) by the pneumatic screw-driving device 7.

In this embodiment, each of the first and second short ribs 60, 60′ has a flat outer side surface 600 perpendicular to the strip bodies 61 and a curved inner side surface 600′, and each of the first and second wings 65, 65′ is configured as a plate parallel to the strip bodies 61.

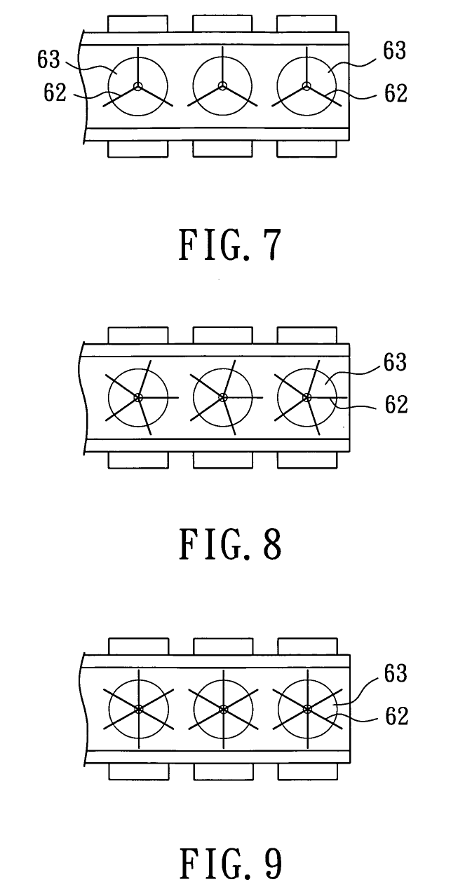

The number of the clamping arms 63 of each of the screw-holding strip portions 6 may be changed, as shown in FIGS. 7 to 9.

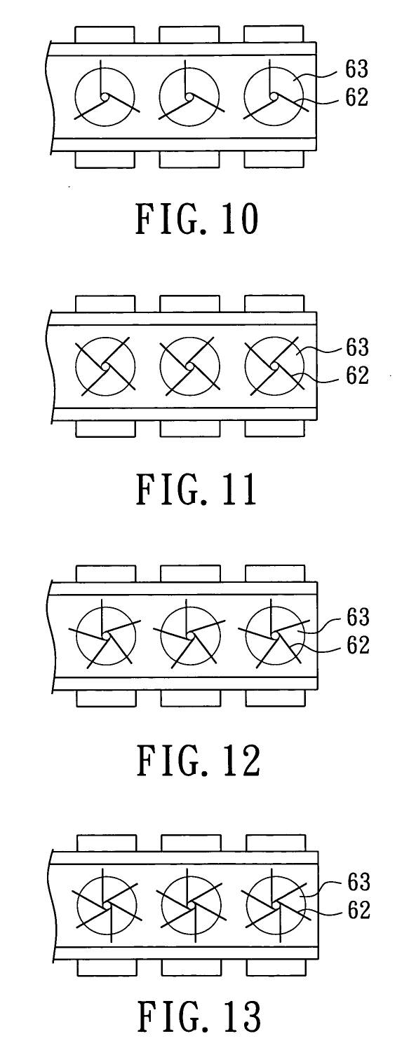

Alternatively, both the number and shape of the clamping arms 63 may be changed, as shown in FIGS. 10 to 13.

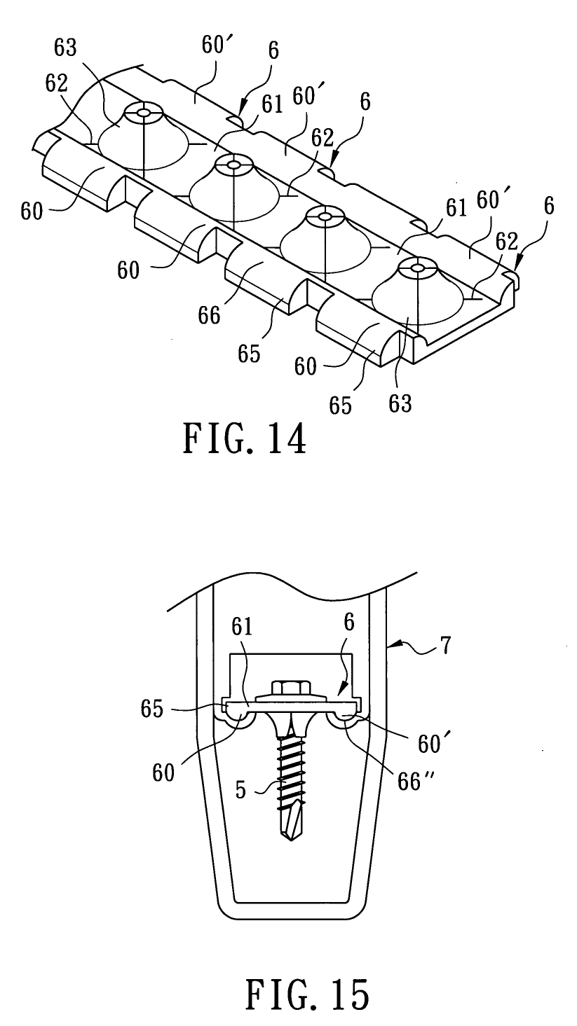

Referring to FIGS. 14 and 15, the shape of an assembly of the first short rib 60 and the first wing 65 of each of the screw-holding strip portions 6 may be changed to have a curved top surface 66″ extending from the first short rib 60 to the first wing 65. Such shape change may also be made to an assembly of the second short rib 60′ and the second wing 65′ of each of the screw-holding strip portions 6.

With this invention thus explained, it is apparent that numerous modifications and variations can be made without departing from the scope and spirit of this invention. It is therefore intended that this invention be limited only as indicated by the appended claims.

I claim:

1. A screw strip for holding a plurality of screws, the screws extending through said screw strip, said screw strip having a plurality of screw-holding strip portions for holding respectively the screws, each of said screw-holding strip portions comprising:
an annular strip body having a side surface;
a pair of parallel first and second short ribs extending respectively and integrally from two opposite sides of said side surface of said strip body; and
a plurality of resilient clamping arms extending from an inner periphery of said side surface of said strip body for clamping a corresponding one of the screws thereamong;
wherein any two adjacent ones of said first short ribs are interconnected integrally such that said first short ribs constitute cooperatively a first long rib extending along a full length of said screw strip, any two adjacent ones of said second short ribs being also interconnected integrally such that said second short ribs constitute cooperatively a second long rib extending along the full length of said screw strip, each of said screw-holding strip portions further having a pair of first and second wings extending respectively and integrally from said opposite sides of a corresponding one of said strip bodies away from each other and disposed respectively in proximity to said first and second short ribs of the corresponding one of said screw-holding strip portions, any two adjacent ones of said first wings being spaced apart from each other so as to define a first positioning notch therebetween, any two adjacent ones of said second wings being also spaced apart from each other so as to define a second positioning notch therebetween.

2. The screw strip as claimed in claim 1, wherein each of said first and second short ribs has a flat outer side surface perpendicular to said strip bodies and a curved inner side surface, and each of said first and second wings is configured as a plate parallel to said strip bodies.

3. The screw strip as claimed in claim 1, wherein an assembly of said first short rib and said first wing of each of said screw-holding strip portions has a curved top surface extending from said first short rib to said first wing, and an assembly of said second short rib and said second wing of each of said screw-holding strip portions also has a curved top surface extending from said second short rib to said second wing.
